(19) United States
(12) Patent Application Publication
(10) Pub. No.: US 2026/0249645 A1
(43) Pub. Date: Aug. 27, 2026

(54) BICYCLE RIM WITH SPOKE HOLE BASE RING AND METHOD FOR MANUFACTURING THE SAME

(71) Applicant: Xiamen Carbonking Composites Technology Co., Ltd., Xiamen (CN)

(72) Inventors: Wurui LIU, Xiamen (CN); Peilong XIAO, Xiamen (CN)

(21) Appl. No.: 19/652,011

(22) Filed: Apr. 20, 2026

Related U.S. Application Data
(63) Continuation-in-part of application No. 19/412,445, filed on Dec. 8, 2025.
Application No. 19/412,445 is a continuation-in-part of application No. 19/260,336, filed on Jul. 4, 2025.

(30) Foreign Application Priority Data
Dec. 10, 2024 (CN) 202411807398.X
Feb. 26, 2025 (CN) 202510220746.1

(51) Int. Cl. B60B 21/06

(52) U.S. Cl. CPC B60B 21/062; B60B 21/064

(57) ABSTRACT

The present disclosure provides a bicycle rim with a spoke hole base ring and a method for manufacturing the same. The bicycle rim includes a rim body, the spoke hole base ring, a spoke nut, and a spoke. An annular closed chamber is disposed in the rim body, the spoke hole base ring is disposed on a bottom wall, corresponding to a radial inner side of the closed chamber, of the rim body, the spoke hole base ring includes a ring belt and a plurality of spoke hole bases disposed on the ring belt, a spoke hole is disposed on the spoke hole base, a nipple-threaded end of the spoke passes through the spoke hole and is coaxially fitted with the spoke nut, and a bottom of the spoke nut is in surface-to-surface contact with the spoke hole base to achieve tight abutment and fixed positioning.

### CROSS-REFERENCE TO RELATED APPLICATIONS

This application is a continuation-in-part of U.S. Patent Application No. 19/412,445, filed on December 8, 2025, which is a continuation-in-part of U.S. Patent Application No. 19/260,336, filed on July 14, 2025. U.S. Patent Application No. 19/260,336 claims priority to Chinese Patent Application No. 202411807398.X, filed on December 10, 2024, and Chinese Patent Application No. 202510220746.1, filed on February 26, 2025. U.S. Patent Application Nos. 19/412,445 and 19/260,336, and Chinese Patent Application Nos. 202411807398.X and 202510220746.1 are incorporated herein by reference.

### TECHNICAL FIELD

The present disclosure relates to the technical field of bicycle rims, and in particular, to a bicycle rim with a spoke hole base ring and a method for manufacturing the same.

### BACKGROUND

Refer to FIG. 1 to FIG. 4. At present, a spoke hole 3’ is provided on a circumferential inner wall of a bicycle rim body 1’, and a nipple-threaded end of a spoke 4’ passes through the spoke hole 3’ and is fitted with a spoke nut 2’. A mounting direction of the spoke nut 2’ is consistent with a radial direction of the rim body 1’. However, a mounting direction of the spoke 4’ has a plurality of different angles, and is different from the radial direction of the rim body 1’. As a result, the spoke nut 2’ and a spoke 4’ corresponding to the spoke nut 2’ cannot be located on a same axis, and one side of the spoke 4’ is in contact with the spoke nut 2’ after displacement and is extruded into a bent angle (as shown at arrows shown in FIG. 2 and FIG. 3). Therefore, the spoke is easy to break after long-term use, and the other side of the spoke is easy to loosen because of not in contact with the spoke nut, resulting in reduction of spoke 4’ tension. Therefore, adjustment needs to be performed frequently, which is troublesome. In addition, when one spoke 4’ is loosened, stress of other spokes 4’ becomes large. Due to this chain reaction, multiple spokes 4’ are loosened and damaged. Furthermore, as shown in FIG. 4, since a threaded hole is formed at a center of a bottom side of the spoke nut 2’, a bottom surface of the spoke nut 2’ is annular. The bottom surface of the spoke nut 2’ is disposed obliquely, so that one end of the bottom surface of the spoke nut 2’ is in point contact with an inner bottom wall 11’ of the rim body 1’. This further prevents tight abutment and fixed positioning, so that the spoke nut 2’ cannot be accurately mounted and is easy to loosen and displace, posing a high risk and potential safety hazard for a user during riding. Furthermore, to ensure that the rim body 1’ is not destroyed while the spoke 4’ is under a high tensile force, a thicker wall thickness of the rim body 1’ is designed at the position of the spoke hole 3’. As a result, a thickness of the inner wall of the rim body 1’ is large, and weight is not light enough.

### SUMMARY

The present disclosure aims to provide a bicycle rim with a spoke hole base ring, to resolve the above technical problems.

To achieve the above objective, a technical solution adopted by the present disclosure is as follows: a bicycle rim with a spoke hole base ring is provided, and includes a rim body, the spoke hole base ring, a spoke nut, and a spoke, where an annular closed chamber is disposed in the rim body, the spoke hole base ring is disposed on a bottom wall, corresponding to a radial inner side of the closed chamber, of the rim body, the spoke hole base ring includes a ring belt and a plurality of spoke hole bases disposed on the ring belt, a spoke hole is disposed on the spoke hole base, a nipple-threaded end of the spoke passes through the spoke hole and is coaxially fitted with the spoke nut, and a bottom of the spoke nut is in surface-to-surface contact with the spoke hole base to achieve tight abutment and fixed positioning.

Preferably, the spoke hole base is disposed on a sidewall of an outer ring of the ring belt, a surface of the spoke hole base is a concave spherical surface, a bottom surface of the spoke nut is a convex spherical surface, the convex spherical surface of the spoke nut and the concave spherical surface of the spoke hole base have a same radius, and the bottom surface of the spoke nut is in spherical contact with the concave spherical surface of the spoke hole base to achieve tight abutment and fixed positioning.

Preferably, a radius of the concave spherical surface of the spoke hole base ranges from 80mm to 120mm.

Preferably, an axis of the spoke, an axis of the spoke hole, and a normal line of the concave spherical surface of the spoke hole base at the center of the spoke hole are collinear.

Preferably, the spoke hole base is disposed on a sidewall of an outer ring of the ring belt, a surface of the spoke hole base is an inclined plane, a bottom surface of the spoke nut is a flat surface, and the bottom surface of the spoke nut is in planar contact with the surface of the spoke hole base to achieve tight abutment and fixed positioning.

Preferably, an axis of the spoke and an axis of the spoke hole are respectively perpendicular to the inclined plane of the spoke hole base.

Preferably, the spoke hole base is disposed on a sidewall of an outer ring of the ring belt; a positioning groove is provided on a surface, corresponding to the spoke hole, of the spoke hole base; the bottom of the spoke nut is fixedly mounted in the positioning groove; and a bottom surface of the spoke nut is tightly abutted against an inner groove surface of the positioning groove to achieve fixed positioning.

Preferably, an axis of the spoke, an axis of the spoke hole, and an axis of the positioning groove are all collinear.

Preferably, the positioning groove is cylindrical or conical, and a shape of the bottom of the spoke nut corresponds exactly to a shape of the positioning groove.

Preferably, the spoke hole base ring includes a plurality of spoke hole base segments that are sequentially spliced end to end.

Preferably, there are six spoke hole base segments, four spoke hole bases are disposed on each spoke hole base segment, and inclination angles of spoke holes on the four spoke hole bases are different from each other.

Preferably, two ends of the spoke hole base segment are respectively extended with an upper connecting piece and a lower connecting piece, and two adjacent spoke hole base segments are attached and spliced one above the other through the upper connecting piece and the lower connecting piece.

Preferably, a transverse cross-section of the spoke hole base is a circle, an ellipse, a square, a trapezoid, or a triangle.

Preferably, a radial outer side, corresponding to the closed chamber, of the rim body extends with a rim bed for accommodating a tire.

Preferably, a piece of prepreg fiber cloth is wrapped on a surface of the spoke hole base ring.

The present disclosure further provides a method for manufacturing the bicycle rim with a spoke hole base ring. The method includes:

S1, manufacturing a spoke hole base ring with a spoke hole base via a special die and a carbon fiber material;

S2, embedding the spoke hole base ring in the bottom wall of the rim body with the carbon fiber material in a pre-molding process, to form an intact rim, putting a pre-molded semi-finished product into a rim molding die, placing the rim molding die in molding equipment, filling, in a die closing state, high-pressure gas in a molding gas bag, and pressurizing and heating to 150° to 160° for molding and solidifying for not less than 30 minutes;

S3, taking a molded rim from the die; trimming, taking the molding gas bag, and inspecting flatness and roundness of the rim;

S4, processing the spoke hole, which is to provide, on the spoke hole base, the spoke hole that is perpendicular to the surface of the spoke hole base; and

S5, threading the nipple-threaded end of the spoke through the spoke hole, coaxially assembling the nipple-threaded end with the spoke nut, and mounting a spoke head end of the spoke on a hub, to enable a mounting direction of the spoke nut to be the same as a mounting direction of the spoke.

The present disclosure has the following beneficial effects.

The present disclosure includes a rim body, the spoke hole base ring, a spoke nut, and a spoke. An annular closed chamber is disposed in the rim body, the spoke hole base ring is disposed on a bottom wall, corresponding to a radial inner side of the closed chamber, of the rim body, the spoke hole base ring includes a ring belt and a plurality of spoke hole bases disposed on the ring belt, a spoke hole is disposed on the spoke hole base, a nipple-threaded end of the spoke passes through the spoke hole and is coaxially fitted with the spoke nut, and a bottom of the spoke nut is in surface-to-surface contact with the spoke hole base to achieve tight abutment and fixed positioning, to enable a mounting direction of the spoke nut to be the same as a mounting direction of the spoke. This ensures precise mounting of the spoke nut and enhances mounting stability thereof. In this technical solution, the spoke nut and a spoke corresponding to the spoke nut are located on a same axis. This prevents one side of the spoke from being in contact with the spoke nut after displacement and from being extruded into a bent angle, thereby preventing the spoke from being broken, and prevents the other side of the spoke from not being in contact with the spoke nut, thereby preventing reduction of spoke tension. Therefore, unnecessary adjustment is avoided, and the bicycle rim with a spoke hole base ring is more worry-free and durable. In addition, one spoke is prevented from loosening, thereby preventing stress of other spokes from becoming large, and preventing multiple spokes from being loosened and damaged due to chain reaction. Therefore, potential risks are eliminated, and the riding safety of users is improved. Furthermore, the spoke hole base ring is disposed, so that a bearing force of the rim is large, and the bottom wall, on the inner side, of the rim can be made thinner and lighter, thereby reducing the weight of the whole rim and meeting the requirement for lightweight of the rim.

### BRIEF DESCRIPTION OF DRAWINGS

FIG. 1 is a structural schematic diagram of a bicycle rim in a conventional technology;

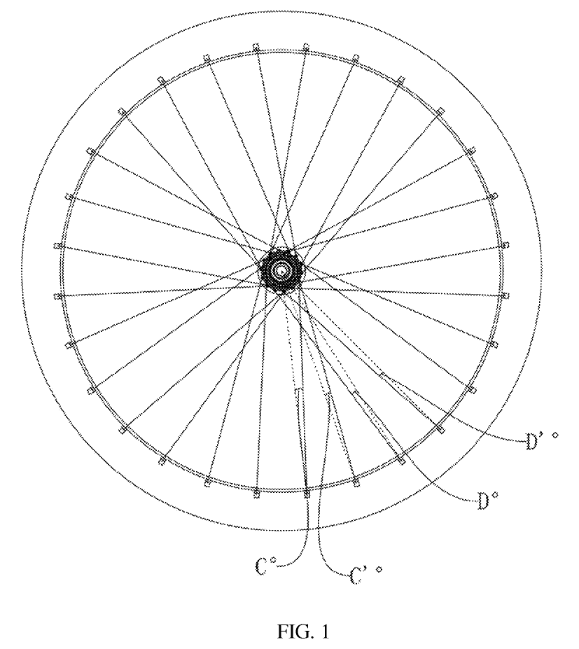

FIG. 2 is a schematic diagram of a bent angle of a spoke of a bicycle rim at a transverse sectional view in a conventional technology;

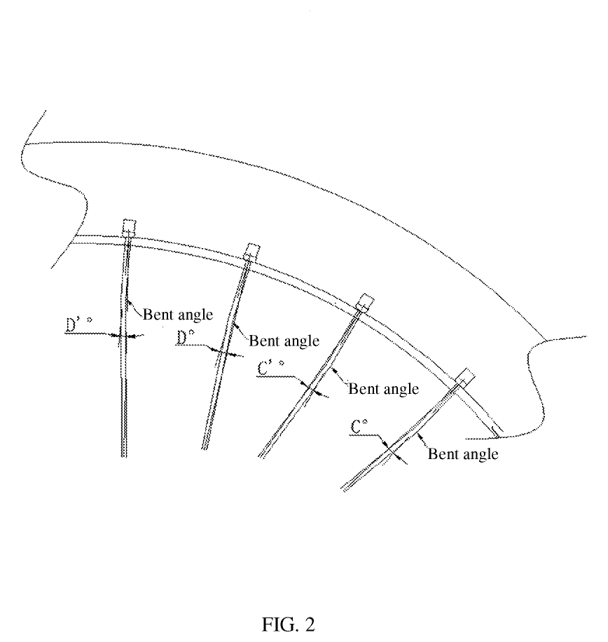

FIG. 3 is a schematic diagram of a bent angle of a spoke of a bicycle rim at a longitudinal sectional view in a conventional technology;

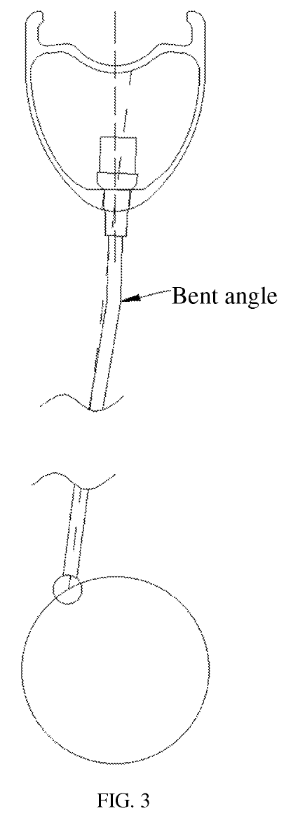

FIG. 4 is a schematic diagram showing point-contact mounting between one end of a spoke nut of a bicycle rim and an inner bottom wall of a rim body in a conventional technology;

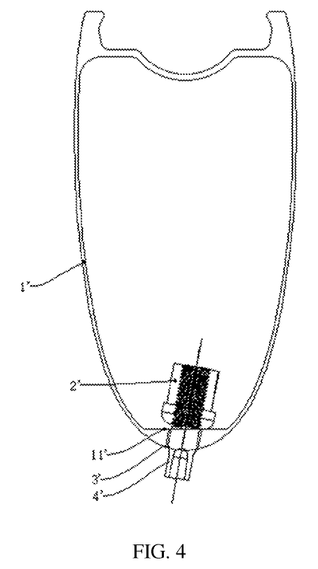

FIG. 5 is a schematic structural diagram of a bicycle rim according to Embodiment 1 of the present disclosure;

FIG. 6 is a partially enlarged schematic view of the bicycle rim at a transverse sectional view according to Embodiment 1 of the present disclosure;

FIG. 7 is a schematic diagram of the bicycle rim at a longitudinal sectional view according to Embodiment 1 of the present disclosure;

FIG. 8 is an assembly view of a spoke according to Embodiment 1 of the present disclosure;

FIG. 9 is a partially enlarged schematic view of FIG. 8;

FIG. 10 is an assembly view of another spoke according to Embodiment 1 of the present disclosure;

FIG. 11 is a partially enlarged schematic view of FIG. 10;

FIG. 12 is a schematic structural diagram of a spoke hole base ring according to Embodiment 1 of the present disclosure;

FIG. 13 is a schematic structural diagram of a spoke hole base segment according to Embodiment 1 of the present disclosure;

FIG. 14 is a half-sectional view of the spoke hole base segment according to Embodiment 1 of the present disclosure;

FIG. 15 is a structural schematic diagram of a spoke nut according to Embodiment 1 of the present disclosure;

FIG. 16 is a schematic diagram showing a spoke nut being mounted on a surface of a spoke hole base according to Embodiment 1 of the present disclosure; and

FIG. 17 is a schematic structural diagram of a spoke hole base ring according to Embodiment 2 of the present disclosure;

FIG. 18 is a half-sectional view of the spoke hole base ring according to Embodiment 2 of the present disclosure;

FIG. 19 is a structural schematic diagram of a spoke nut according to Embodiment 2 of the present disclosure;

FIG. 20 is a structural schematic diagram of a spoke nut according to Embodiment 3 of the present disclosure; and

FIG. 21 is a structural schematic diagram of a spoke nut according to Embodiment 4 of the present disclosure.

### Reference numerals:

In the conventional technology: 1’: rim body, 11’: inner bottom wall of rim body, 2’: spoke nut, 3’: spoke hole, 4’: spoke.

In the present disclosure: 1: rim body; 11: closed chamber; 12: bottom wall; 13: rim bed; 2: spoke hole base ring; 20: spoke hole base segment; 21: ring belt; 211: outer ring sidewall; 22: spoke hole base; 221: concave spherical surface; 222: inclined plane; 223: positioning groove; 23: upper connecting piece; 24: lower connecting piece; 3: spoke nut; 31: flat surface; 32: convex spherical surface; 4: spoke; 41: nipple-threaded end; 42: spoke head end; 5: hub; 6: spoke hole; 7: prepreg fiber cloth.

### DESCRIPTION OF EMBODIMENTS

To further illustrate the embodiments, the present disclosure provides accompanying drawings. The accompanying drawings, as a part of the present disclosure, are mainly used to illustrate the embodiments, and can explain the operating principles of the embodiments with reference to the related descriptions in this specification. With reference to such content, those of ordinary skill in the art can understand other possible implementations and the advantages of the present disclosure. Components in the drawings are not drawn to scale, and similar reference numerals are usually used to represent similar components.

### Embodiment 1

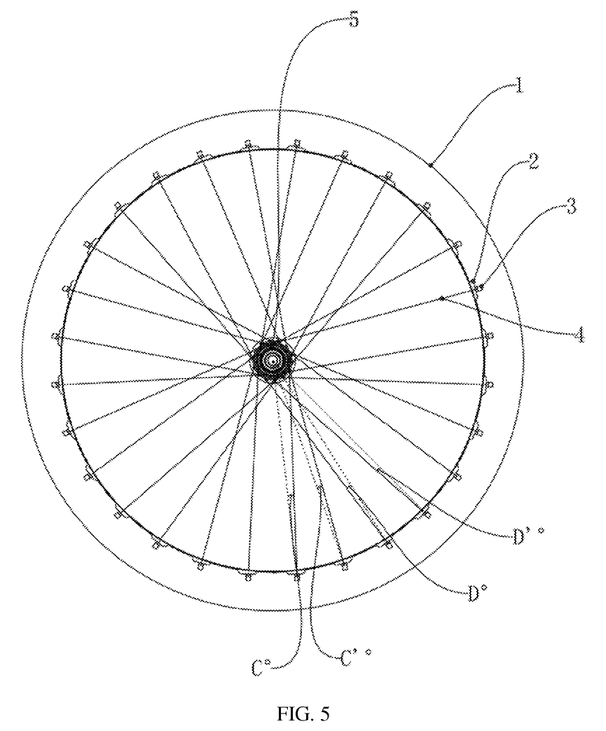

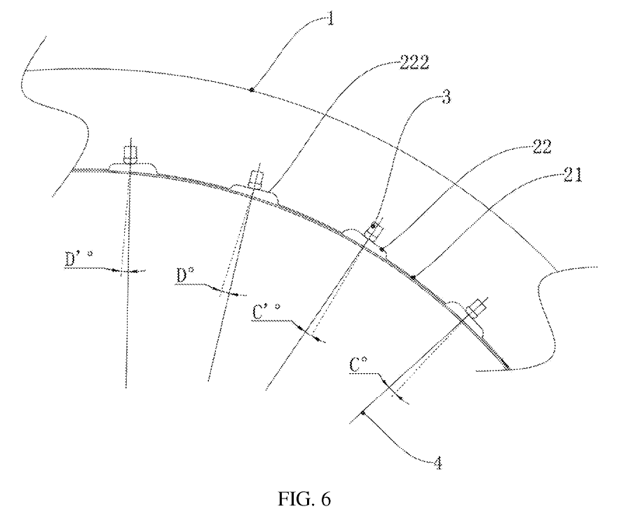

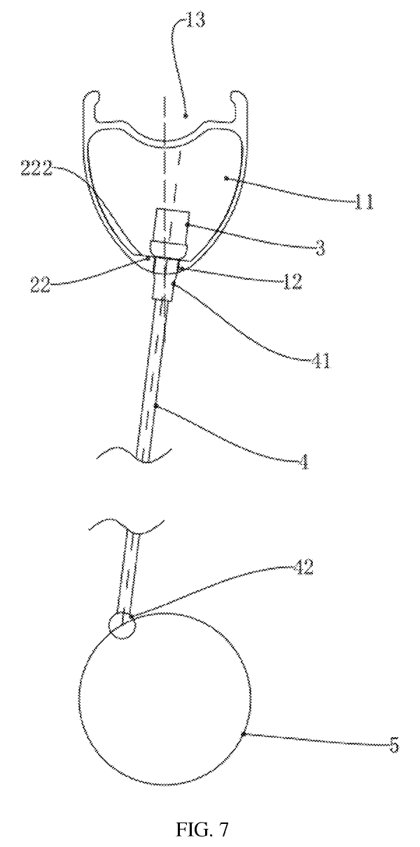

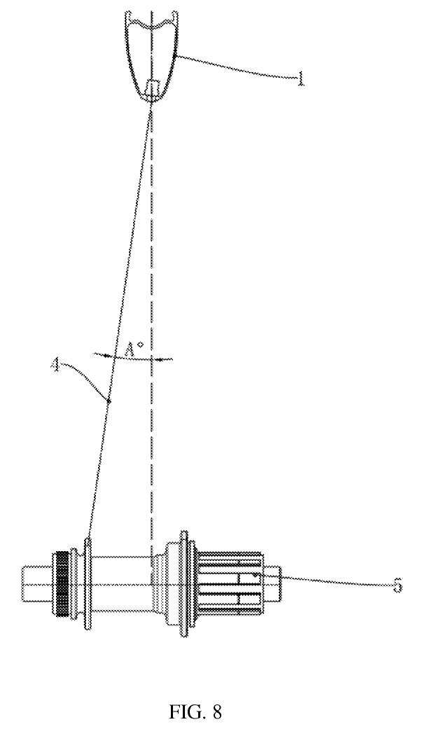

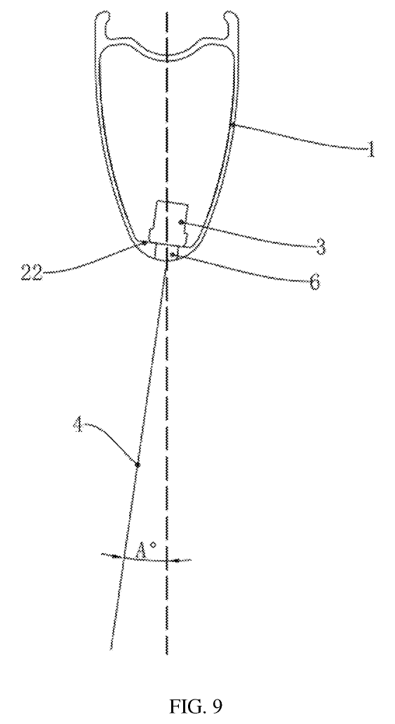

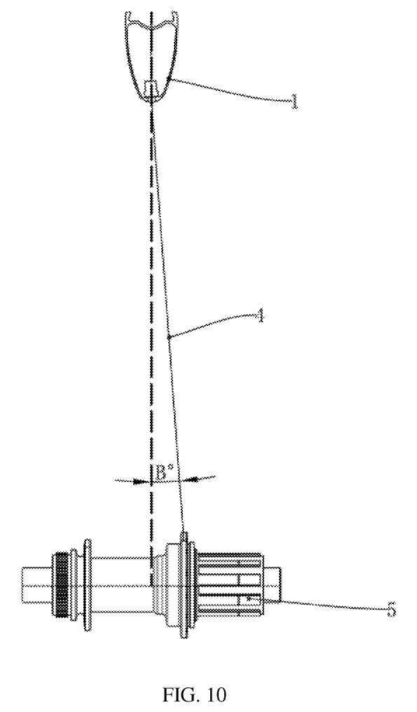

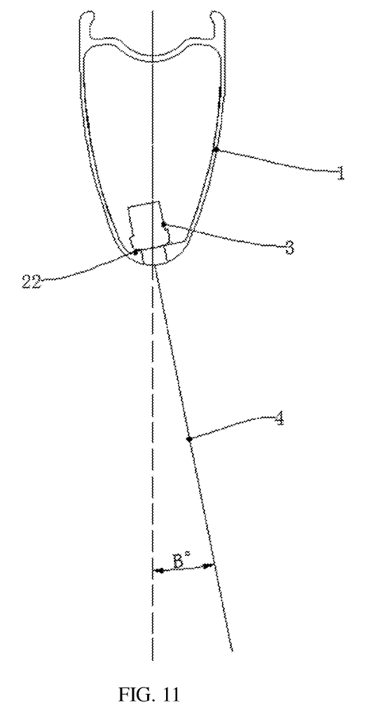

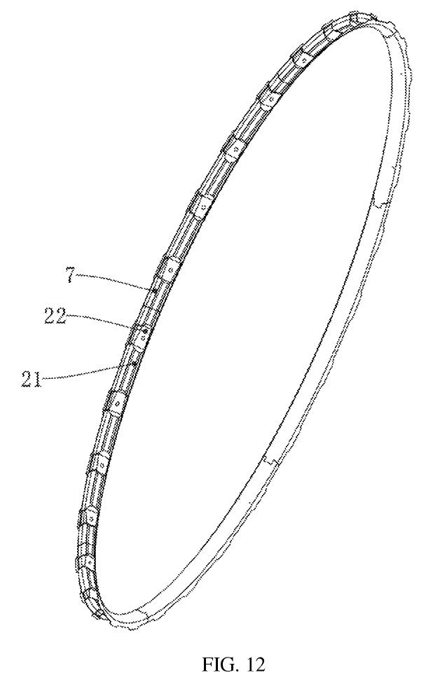

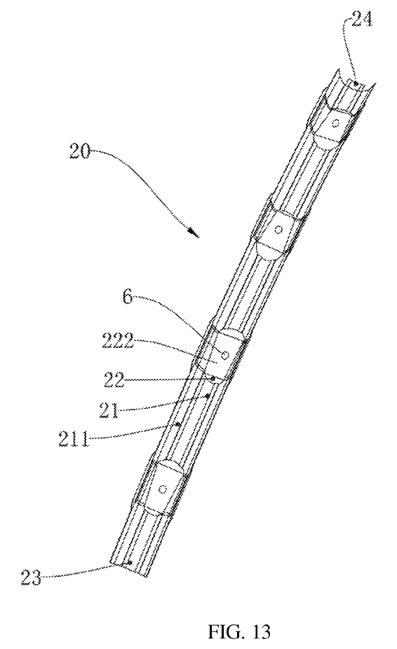

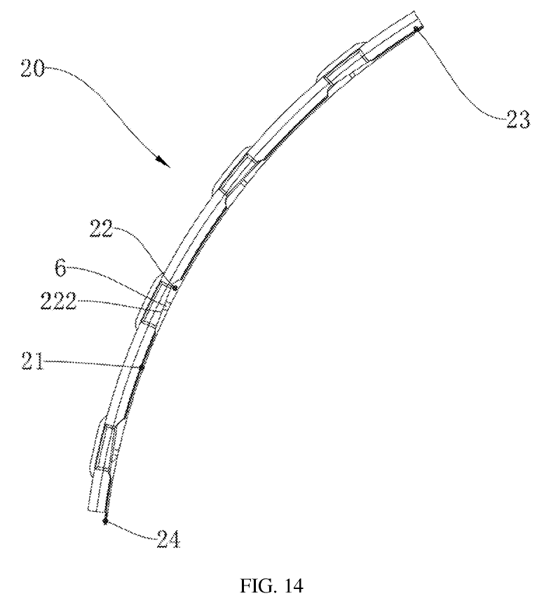

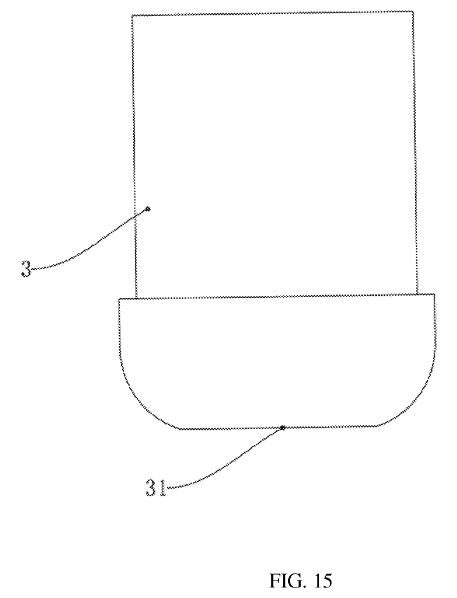

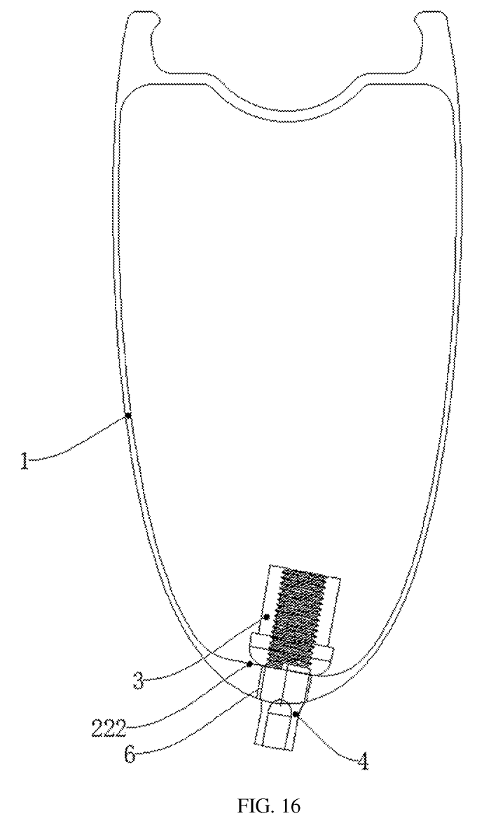

Refer to FIG. 5 to FIG. 16. As an embodiment of the present disclosure, a bicycle rim with a spoke hole base ring is provided, and includes a rim body 1, the spoke hole base ring 2, a spoke nut 3, and a spoke 4. The rim body 1 is a carbon fiber structure and internally provided with an annular closed chamber 11, the spoke hole base ring 2 is disposed on a bottom wall 12, corresponding to a radial inner side of the closed chamber 11, of the rim body 1, the spoke hole base ring 2 includes a ring belt 21 and a plurality of spoke hole bases 22 disposed on the ring belt 21, the spoke hole base 22 is disposed on an outer ring sidewall 211 of the ring belt 21, a spoke hole 6 is provided on the spoke hole base 22, a nipple-threaded end 41 of the spoke 4 passes through the spoke hole 6 and is coaxially fitted with the spoke nut 3, a spoke head end 42 of the spoke 4 is mounted on a hub 5, and a bottom of the spoke nut 3 is in surface-to-surface contact with the spoke hole base 22 to achieve tight abutment and fixed positioning. Specifically, a surface of the spoke hole base 22 is an inclined plane 222, an axis of the spoke 4 and an axis of the spoke hole 6 are respectively perpendicular to the inclined plane 222 of the spoke hole base 22. A bottom surface of the spoke nut 3 is a flat surface 31, and the bottom surface of the spoke nut 3 is in planar contact with the surface of the spoke hole base 22 to achieve tight abutment and fixed positioning, to enable a mounting direction of the spoke nut 3 to be the same as a mounting direction of the spoke 4 (namely, the spoke nut 3 and the spoke 4 are coaxially disposed). This ensures precise mounting of the spoke nut 3 and enhances mounting stability thereof. In this technical solution, the spoke nut 3 and a spoke 4 corresponding to the spoke nut 3 are located on a same axis. This prevents one side of the spoke 4 from being in contact with the spoke nut 3 after placement and from being extruded into a bent angle, thereby preventing the spoke 4 from being broken, and prevents the other side of the spoke 4 from not being in contact with the spoke nut 3, thereby preventing reduction of spoke 4 tension. Therefore, unnecessary adjustment is avoided, and the bicycle rim with a spoke hole base ring is more worry-free and durable. In addition, one spoke 4 is prevented from loosening, thereby preventing stress of other spokes 4 from becoming large, and preventing multiple spokes 4 from being loosened and damaged due to chain reaction. Therefore, potential risks are eliminated, and the riding safety of users is improved. Furthermore, the spoke hole base ring 2 is disposed, so that a bearing force of the rim is large, and the bottom wall 12, on the inner side, of the rim can be made thinner and lighter, thereby reducing the weight of the whole rim and meeting the requirement for lightweight of the rim. This results in failure to precise mounting of the spoke nut and makes the spoke nut easy to loosen and displace.

In this embodiment, the spoke hole base ring 2 includes six spoke hole base segments 20, four spoke hole bases 22 are disposed on each spoke hole base segment 20, and inclination angles of spoke holes 6 on the four spoke hole bases 22 are different from each other. This reduces costs of developing and manufacturing corresponding dies. Certainly, a quantity of spoke hole base segments 20, spoke hole bases 22, or spoke holes can be adapted based on an actual quantity of spokes. For example, the spoke hole base ring may be formed by sequentially splicing four spoke hole base segments 20 end to end, which is not limited herein.

In this embodiment, two ends of the spoke hole base segment 20 are respectively extended with an upper connecting piece 23 and a lower connecting piece 24, and two adjacent spoke hole base segments 20 are attached and spliced one above the other through the upper connecting piece 23 and the lower connecting piece 24. This ensures that a thickness of the ring belt 21 at a splicing position is basically the same as that at another position, and ensures better connection stability.

In this embodiment, a transverse cross-section of the spoke hole base 22 is a circle, an ellipse, a square, a trapezoid, or a triangle.

In this embodiment, a radial outer side, corresponding to the closed chamber 11, of the rim body 1 extends with a rim bed 13 for accommodating a tire.

In this embodiment, a piece of prepreg fiber cloth is wrapped on a surface of the spoke hole base ring. This further improves solidification stability of the spoke hole base ring in the rim body 1.

The present disclosure further provides a method for manufacturing the bicycle rim with a spoke hole base ring 2. The method includes the following steps.

S1: Manufacture a spoke hole base ring 2 with a spoke hole base 22 via a special die and a carbon fiber material.

S2: Embed a spoke hole base ring 2 in a bottom wall of a rim body with the carbon fiber material in a pre-molding process, to form an intact rim, put a pre-molded semi-finished product into a rim molding die, place the rim molding die in molding equipment, fill, in a die closing state, high-pressure gas in a molding gas bag, and pressurize and heat to 150° to 160° for molding and solidifying for not less than 30 minutes.

S3: Take a molded rim from the die; trim, take the molding gas bag, and inspect flatness and roundness of the rim.

S4: Process the spoke hole 6, which is to provide, on the spoke hole base 22, the spoke hole 6 that is perpendicular to the surface of the spoke hole base 22.

S5: Thread the nipple-threaded end 41 of the spoke 4 through the spoke hole 6, coaxially assemble the nipple-threaded end 41 with the spoke nut 3, and mount a spoke head end 42 of the spoke 4 on a hub 5, to enable a mounting direction of the spoke nut 3 to be the same as a mounting direction of the spoke 4.

Embodiment 2: For the sake of brevity, the embodiment mainly describes differences from Embodiment 1.

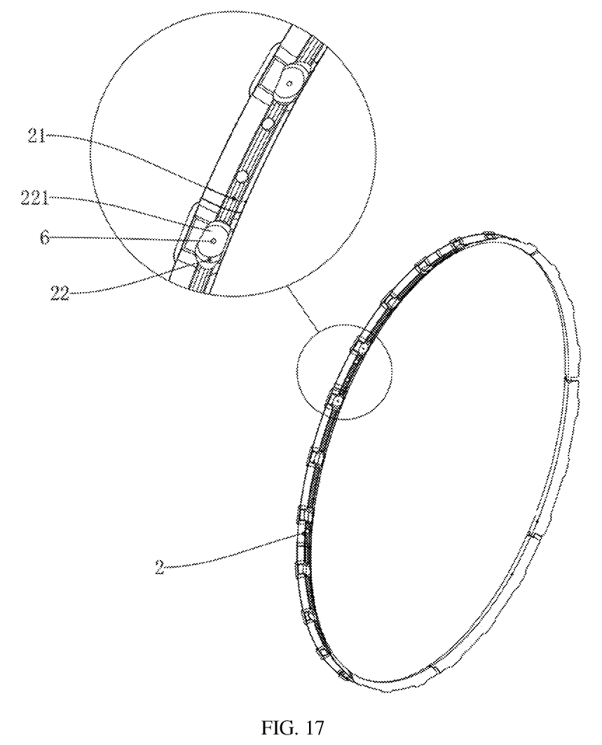

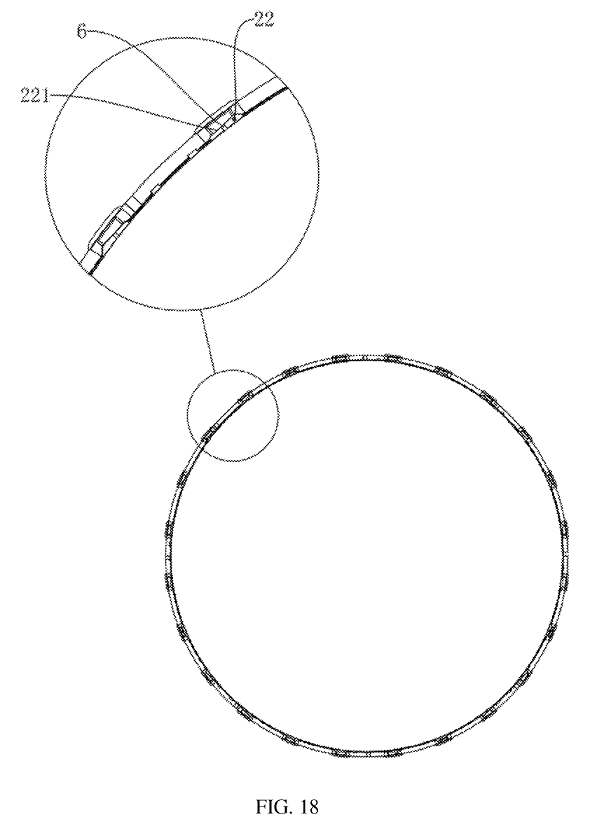

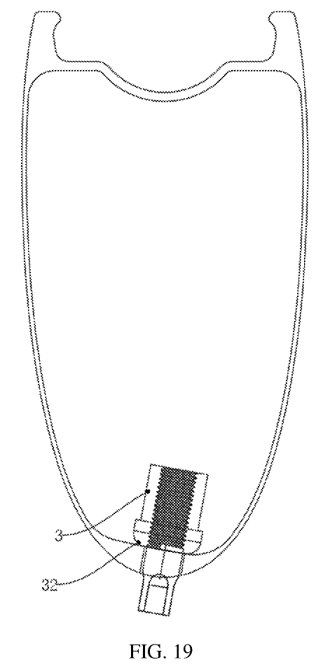

Refer to FIG. 17 to FIG. 19. As an embodiment of the present disclosure, a bicycle rim with a spoke hole base ring is provided. The surface of the spoke hole base 22 is a concave spherical surface 221 , as contrary to a flat surface. An axis of the spoke 4 and an axis of the spoke hole 6 are respectively perpendicular to a tangent plane of the concave spherical surface 221 of the spoke hole base 22 at the center of the spoke hole 6, that is, the axis of the spoke 4, the axis of the spoke hole 6, and the normal line of the concave spherical surface 221 of the spoke hole base 22 are collinear at the center of the spoke hole 6. Thus, the embodiment provides a spoke hole base 22 that is not perpendicular to the axis of the spoke hole 6. The spoke hole base surface is configured to be aligned with the convex spherical surface 32 of the spoke nut 3 to have a right alignment where the convex spherical surface 32 fits into the concave spoke hole base surface. Thus,a mating of the two surfaces has one right aligned position and several unaligned positions. Hence,this present concept includes two mating shapes which are configured to be aligned to aright position to mate with each other, wherein there is only one right alignment position where there is a fit between the mating shapes. This is opposed to where the surfaces are flat and where there may be several right alignment positions between the nut 3 and the base surface. Thus, this present concept can prevent the spoke nut 3 from moving in the concave spherical surface of the spoke hole base 22.

This arrangement can further improve tightness of abutment between the bottom surface of the spoke nut 3 and the surface of the spoke hole base 22, thereby enhancing assembly stability between the spoke nut 3 and the spoke 4, maintaining a coaxial assembly effect, and further ensuring riding safety and reliability. This arrangement may also provide an increased contact area between the spoke hole surface and the spoke nut 3, which may prevent misalignment.

In the embodiment, the radius of the concave spherical surface 221 of the spoke hole base 22 is 100mm. Of course, other values of the radius of the concave spherical surface 221 within the range of 80 mm-120mm are also acceptable, can be specifically adjusted according to actual needs, and are not limited herein.

In the embodiment, a bottom surface of the spoke nut 3 is a convex spherical surface 32, the convex spherical surface 32 of the spoke nut 3 and the concave spherical surface 221 of the spoke hole base 22 have a same radius, and the bottom surface of the spoke nut 3 is in spherical contact with the concave spherical surface 221 of the spoke hole base 22 to achieve tight abutment and fixed positioning, preventing the spoke nut 3 from loosening or displacement, thus ensuring riding safety.

Embodiment 3: For the sake of brevity, the embodiment mainly describes differences from Embodiment 1.

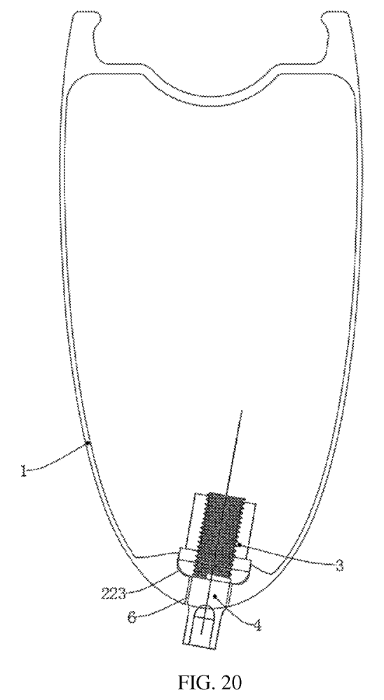

Refer to FIG. 20. As an embodiment of the present disclosure, a bicycle rim with a spoke hole base ring is provided, the spoke hole base 22 is disposed on an outer ring sidewall of the ring belt 21, and a positioning groove 223 is provided on a surface, corresponding to the spoke hole 6, of the spoke hole base 22. The bottom of the spoke nut 3 is fixedly mounted in the positioning groove 223; and a bottom surface of the spoke nut 3 is tightly abutted against an inner groove surface of the positioning groove 223 to achieve fixed positioning. An axis of the spoke 4, an axis of the spoke hole 6, and an axis of the positioning groove 223 are all collinear, to enable a mounting direction of the spoke nut 3 to be the same as a mounting direction of the spoke 4 (namely, the spoke nut 3 and the spoke 4 are coaxially disposed). The spoke nut 3 and a spoke 4 corresponding to the spoke nut 3 are located on a same axis. This prevents one side of the spoke 4 from being in contact with the spoke nut 3 after displacement and from being extruded into a bent angle, thereby preventing the spoke from being broken, and prevents the other side of the spoke 4 from not being in contact with the spoke nut 3, thereby preventing reduction of spoke 4 tension. Therefore, unnecessary adjustment is avoided, and the bicycle rim with a spoke hole base ring is more worry-free and durable. In addition, one spoke 4 is prevented from loosening, thereby preventing stress of other spokes 4 from becoming large, and preventing multiple spokes 4 from being loosened and damaged due to chain reaction. Therefore, potential risks are eliminated, and the riding safety of users is improved. Furthermore, the spoke hole base ring 2 is disposed, so that a bearing force of the rim is large, and the bottom wall 12, on the inner side, of the rim can be made thinner and lighter, thereby reducing the weight of the whole rim and meeting the requirement for lightweight of the rim. Specifically, the positioning groove 223 is cylindrical, and a shape of the bottom of the spoke nut 3 corresponds exactly to a shape of the positioning groove 223, thereby forming accurate fitting at a unique correct position. Moreover, the spoke nut 3 can be subjected to fixed positioning in both an axial direction and a circumferential direction, preventing the spoke nut 3 from displacement or inclination, thereby further improving mounting stability and reliability of the spoke nut 3.

Embodiment 4: For the sake of brevity, the embodiment mainly describes differences from Embodiment 3.

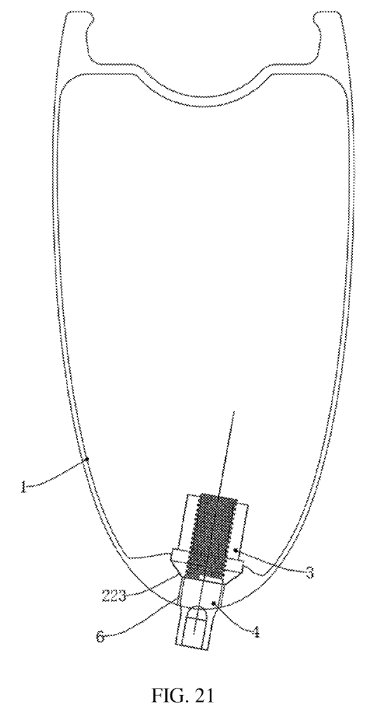

Refer to FIG. 21. As the embodiment of the present disclosure, a bicycle rim with a spoke hole base ring is provided, the positioning groove 223 is conical, and a shape of the bottom of the spoke nut 3 corresponds exactly to a shape of the positioning groove 223, thereby forming accurate fitting at a unique correct position. Moreover, the spoke nut 3 can be subjected to fixed positioning in both an axial direction and a circumferential direction, preventing the spoke nut 3 from displacement or inclination, thereby further improving mounting stability and reliability of the spoke nut 3.

Although the present disclosure is specifically illustrated and described fall combination with preferred implementation solutions, those skilled in the art should understand that various changes may be made to the present disclosure in terms of forms and details without departing from the spirit and scope of the present disclosure defined in the appended claims, which shall fall within the protection scope of the present disclosure.

1. A bicycle rim with a spoke hole base ring, comprising a rim body, the spoke hole base ring, a spoke nut, and a spoke, wherein an annular closed chamber is disposed in the rim body, the spoke hole base ring is disposed on a bottom wall, corresponding to a radial inner side of the annular closed chamber, of the rim body, the spoke hole base ring comprises a ring belt and a plurality of spoke hole bases disposed on the ring belt, a spoke hole is disposed on each of the plurality of spoke hole bases, a nipple-threaded end of the spoke passes through the spoke hole and is coaxially fitted with the spoke nut, and a bottom of the spoke nut is in surface-to-surface contact with a corresponding one of the plurality of spoke hole bases to achieve abutment and fixed positioning.

2. The bicycle rim with the spoke hole base ring according to claim 1, wherein each of the plurality of spoke hole bases is disposed on a sidewall of an outer ring of the ring belt, a surface of each of the plurality of spoke hole bases is a concave spherical surface, a bottom surface of the spoke nut is a convex spherical surface, the convex spherical surface of the spoke nut and the concave spherical surface of the corresponding one of the plurality of spoke hole bases have a same radius, and the bottom surface of the spoke nut is in spherical contact with the concave spherical surface of the corresponding one of the plurality of spoke hole bases to achieve abutment and fixed positioning.

3. The bicycle rim with the spoke hole base ring according to claim 2, wherein the radius of the concave spherical surface of the corresponding one of the plurality of spoke hole bases ranges from 80mm to 120mm.

4. The bicycle rim with the spoke hole base ring according to claim 2, wherein an axis of the spoke, an axis of the spoke hole, and a normal line of the concave spherical surface of the corresponding one of the plurality of spoke hole bases at a center of the spoke hole are collinear.

5. The bicycle rim with the spoke hole base ring according to claim 1, wherein each of the plurality of spoke hole bases is disposed on a sidewall of an outer ring of the ring belt, a surface of each of the plurality of spoke hole bases is an inclined plane, a bottom surface of the spoke nut is a flat surface, and the bottom surface of the spoke nut is in planar contact with the surface of the corresponding one of the plurality of spoke hole bases to achieve abutment and fixed positioning.

6. The bicycle rim with the spoke hole base ring according to claim 5, wherein an axis of the spoke and an axis of the spoke hole are respectively perpendicular to the inclined plane of the corresponding one of the plurality of spoke hole bases.

7. The bicycle rim with the spoke hole base ring according to claim 1, wherein each of the plurality of spoke hole bases is disposed on a sidewall of an outer ring of the ring belt; a positioning groove is provided on a surface, corresponding to the spoke hole, of the corresponding one of the plurality of spoke hole bases; the bottom of the spoke nut is fixedly mounted in the positioning groove; and a bottom surface of the spoke nut is abutted against an inner groove surface of the positioning groove to achieve fixed positioning.

8. The bicycle rim with the spoke hole base ring according to claim 7, wherein an axis of the spoke, an axis of the spoke hole, and an axis of the positioning groove are all collinear.

9. The bicycle rim with the spoke hole base ring according to claim 7, wherein the positioning groove is cylindrical or conical, and a shape of the bottom of the spoke nut corresponds exactly to a shape of the positioning groove.

10. The bicycle rim with the spoke hole base ring according to claim 1, wherein the spoke hole base ring comprises a plurality of spoke hole base segments that are sequentially spliced end to end.

11. The bicycle rim with the spoke hole base ring according to claim 10, wherein the plurality of spoke hole base segments are six spoke hole base segments, four of the plurality of spoke hole bases are disposed on each of the six spoke hole base segments, and inclination angles of spoke holes on the four of the plurality of spoke hole bases are different from each other.

12. The bicycle rim with the spoke hole base ring according to claim 10, wherein two ends of each of the plurality of spoke hole base segments are respectively extended with an upper connecting piece and a lower connecting piece, and two adjacent spoke hole base segments of the plurality of spoke hole base segments are attached and spliced one above the other through the upper connecting piece and the lower connecting piece.

13. The bicycle rim with the spoke hole base ring according to claim 1, wherein a transverse cross-section of each of the plurality of spoke hole bases is a circle, an ellipse, a square, a trapezoid, or a triangle.

14. The bicycle rim with the spoke hole base ring according to claim 1, wherein a radial outer side, corresponding to the annular closed chamber, of the rim body extends with a rim bed for accommodating a tire.

15. The bicycle rim with the spoke hole base ring according to claim 1, wherein a piece of prepreg fiber cloth is wrapped on a surface of the spoke hole base ring.

16. A method for manufacturing the bicycle rim with the spoke hole base ring according to claim 1, comprising:
S1, manufacturing the spoke hole base ring with a spoke hole base of the plurality of spoke hole bases via a die and a carbon fiber material;
S2, embedding the spoke hole base ring in the bottom wall of the rim body with the carbon fiber material in a pre-molding process, to form an intact rim, putting a pre-molded semi-finished product into a rim molding die, placing the rim molding die in molding equipment, filling, in a die closing state, high-pressure gas in a molding gas bag, and pressurizing and heating to 150° to 160° for molding and solidifying for not less than 30 minutes;
S3, taking a molded rim from the die; trimming, taking the molding gas bag, and inspecting flatness and roundness of the molded rim;
S4, processing the spoke hole, which is to provide, on the spoke hole base, wherein the spoke hole is perpendicular to a surface of the spoke hole base; and
S5, threading the nipple-threaded end of the spoke through the spoke hole, coaxially assembling the nipple-threaded end with the spoke nut, and mounting a spoke head end of the spoke on a hub, to enable a mounting direction of the spoke nut to be the same as a mounting direction of the spoke.
